(19) United States
(12) Patent Application Publication
(10) Pub. No.: US 2026/0189442 A1
(43) Pub. Date: Jul. 2, 2026

(54) METHODS AND DEVICES FOR CONFIGURING EXTENDED CYCLIC PREFIX FOR BROADCAST AND MULTICAST TRANSMISSION

(71) Applicant: ZTE CORPORATION, Shenzhen, Guangdong (CN)

(72) Inventors: Xing LIU, Shenzhen (CN); Xianghui HAN, Shenzhen (CN); Shuaihua KOU, Shenzhen (CN); Wei GOU, Shenzhen (CN); Jing SHI, Shenzhen (CN)

(21) Appl. No.: 19/130,800

(22) PCT Filed: Jul. 11, 2023
(86) PCT No.: PCT/CN2023/106820

§ 371 Date: May 16, 2025

(51) Int. Cl. H04L 27/26; H04W 72/0453; H04W 72/30

(52) U.S. Cl. CPC H04L 27/2607; H04W 72/0453; H04W 72/30

(57) ABSTRACT

The present disclosure describes methods, system, and devices for configuring extended cyclic prefix (ECP) for broadcast and/or multicast transmission. One method includes determining, by a user equipment (UE), ECP resource for at least one of broadcast transmission and multicast transmission according to predefined resources; and receiving, by the UE from a base station, a broadcast transmission or multicast transmission in the ECP resource. Another method includes configuring, by a base station, ECP resource for at least one of broadcast transmission and multicast transmission according to predefined resources; and transmitting, by the base station to at least one UE, a broadcast transmission or multicast transmission in the ECP resource.

### CROSS-REFERENCE TO RELATED APPLICATION(S)

The present application is a national phase entry under 35 U.S.C 371 of International Application No. PCT/CN2023/106820, filed on Jul. 11, 2023. The entire contents of the International Patent Application are incorporated herein by reference.

### TECHNICAL FIELD

The present disclosure is directed generally to wireless communications. Particularly, the present disclosure relates to methods and devices for configuring extended cyclic prefix (ECP) for broadcast and/or multicast transmission.

### BACKGROUND

Wireless communication technologies are moving the world toward an increasingly connected and networked society. Multicast and broadcast services (MBS) may be employed in some implementation, wherein a group of UEs are expected to receive the same contents. There are some issues/problems related to MBS. For example, some UE may not be located in vicinity, e.g., some UEs are in cell center but other UEs are at cell edge. In some situations, the UEs located at the cell edge may benefit from single frequency network (SFN) transmission scheme in terms of improving the received SNR (Signal-to-Noise Ratio). Presently, normal CP is allowed only for a limited number of subcarrier spacings, which unnecessarily imposes the limits to the deployments of MBS with low spectral efficiency. Another issue/problem may include how to support extended cyclic prefix (ECP) for broadcast or multicast transmission, wherein larger CP may benefit to increase the cell coverage.

The present disclosure describes various embodiments for configuring ECP for broadcast and/or multicast transmission, addressing at least one of issues/problems discussed above, providing improvement in the technology field of wireless communication and increasing its efficiency and performance.

### SUMMARY

This document relates to methods, systems, and devices for wireless communication, and more specifically, for configuring extended cyclic prefix (ECP) for broadcast and/or multicast transmission. The various embodiments in the present disclosure may increase the resource utilization efficiency, enhance coverage, and/or improve throughput and/or reliability of UE's transmission.

In one embodiment, the present disclosure describes a method for wireless communication. The method includes determining, by a user equipment (UE), extended cyclic prefix (ECP) resource for at least one of broadcast transmission and multicast transmission according to predefined resources; and receiving, by the UE from a base station, a broadcast transmission or multicast transmission in the ECP resource.

In one embodiment, the present disclosure describes a method for wireless communication. The method includes configuring, by a base station, extended cyclic prefix (ECP) resource for at least one of broadcast transmission and multicast transmission according to predefined resources; and transmitting, by the base station to at least one UE, a broadcast transmission or multicast transmission in the ECP resource.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods. The computer-readable medium includes a non-transitory computer-readable medium.

The above and other aspects and their implementations are described in greater detail in the drawings, the descriptions, and the claims.

### BRIEF DESCRIPTION OF THE DRAWINGS

FIG. 1A shows an example of a point-to-point (PTP) radio bearer in a wireless communication system.

FIG. 1B shows an example of a point-to-multipoint (PTM) radio bearer in a wireless communication system.

FIG. 1C shows a schematic diagram of a non-limiting embodiment for wireless communication.

FIG. 1D shows a schematic diagram of another non-limiting embodiment for wireless communication.

FIG. 2 shows an example of a network node.

FIG. 3 shows an example of a user equipment.

FIG. 4A shows a flow diagram of an exemplary method for wireless communication.

FIG. 4B shows a flow diagram of another exemplary method for wireless communication.

FIG. 5A shows a schematic diagram of one non-limiting embodiment for wireless communication.

FIG. 5B shows a schematic diagram of another non-limiting embodiment for wireless communication.

FIG. 5C shows a schematic diagram of another non-limiting embodiment for wireless communication.

FIG. 5D shows a schematic diagram of another non-limiting embodiment for wireless communication.

FIG. 5E shows a schematic diagram of another non-limiting embodiment for wireless communication.

FIG. 6A shows a schematic diagram of another non-limiting embodiment for wireless communication.

FIG. 6B shows a schematic diagram of another non-limiting embodiment for wireless communication.

FIG. 7A shows a schematic diagram of another non-limiting embodiment for wireless communication.

FIG. 7B shows a schematic diagram of another non-limiting embodiment for wireless communication.

FIG. 8A shows a schematic diagram of another non-limiting embodiment for wireless communication.

FIG. 8B shows a schematic diagram of another non-limiting embodiment for wireless communication.

FIG. 8C shows a schematic diagram of another non-limiting embodiment for wireless communication.

FIG. 9A shows a schematic diagram of another non-limiting embodiment for wireless communication.

FIG. 9B shows a schematic diagram of another non-limiting embodiment for wireless communication.

FIG. 9C shows a schematic diagram of another non-limiting embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods and devices for configuring extended cyclic prefix (ECP) for broadcast and/or multicast transmission.

Next generation (NG), for a non-limiting example 5th generation (5G), wireless communication may provide a range of capabilities from downloading with fast speeds to support real-time low-latency communication. The wireless communication may use a radio bearer (RB) for multicast broadcast services (MBS). This range of capabilities may need some characteristics of quality of service (QoS), such as delay, error rate, priority level, and etc. In NG wireless communication, one or more service data flows with same QoS characteristics may be grouped together as a QoS flow. Each QoS flow may be identified by a QoS flow identifier, informing the network components the corresponding characteristics of the QoS flow.

In some implementations with multicast and broadcast services (MBS), a group of UEs are expected to receive the same contents but the UE may not be located in vicinity, e.g., some UEs are in cell center but other UEs are at cell edge, and the larger the cyclic prefix (CP) the larger the cell coverage. The UEs located at the cell edge may benefit from single frequency network (SFN) transmission scheme in terms of improving the received SNR.

In some implementations, more than one transmission and reception points (TRPs) may transmit the same MBS service on the same time/frequency domain resource for a group of UEs. In some implementations, normal CP (NCP) may be only allowed for the 15 kHz and 30 kHz subcarrier spacing, which unnecessarily imposes the limits to the deployments of MBS with low spectral efficiency.

In some implementations with MBS, a same transmission mechanism may be used by the network node (e.g. a base station) for transmitting same information to a group of UEs (e.g., multicast) or all UEs (e.g., broadcast) in a cell. The MBS transmission may be carried on a physical downlink shared channel (PDSCH) which received by the group of UEs or all UEs. The PDSCH carrying MBS information may be called as group-common PDSCH or MBS PDSCH. MBS transmission depends on a configuration of a common frequency resource (CFR). The CFR standardizes a set of common transmission parameters for a group of UEs or all UEs which receiving the MBS, including a frequency range, a numerology, PDCCH monitoring parameters, PDSCH receiving parameters, and the like. The CFR may need to be associated with a specific bandwidth part (BWP). In some implementations, there is a restriction on the frequency range between the CFR and the associated BWP, and the numerology of the CFR may be the same as that of the associated BWP.

In some implementations, the MBS may be further classified into a multicast service and a broadcast service. The broadcast service may serve UEs in all radio resource control (RRC) states, i.e., RRC idle, RRC inactive, and RRC connected states. For UEs in RRC idle or RRC inactive states, only control resource set with index zero (CORESET #0) defined initial DL BWP may be valid, that is, the bandwidth, numerology of the initial DL BWP equals to the bandwidth of CORESET #0. Therefore, the broadcast CFR exists based on the initial DL BWP or CORESET #0. In some implementations, to increase the broadcast capacity, the broadcast CFR may be configured to a frequency range greater than or equal to the bandwidth of CORESET #0. While the multicast CFR may depend on any active DL BWP, and a frequency range of the CFR needs to be limited to be within the range of the active DL BWP, so as to ensure that the UE can receive both multicast and unicast.

In some implementations, support of extended CP (ECP) may be used to resist larger delay spread caused by the SFN transmission. One of the problems/issues may include how to support ECP for broadcast or multicast transmission under the framework of CFR, which may be defined in new radio (NR) MBS. The present disclosure describes various embodiments for configuring ECP for broadcast and/or multicast transmission, addressing at least one of issues/problems discussed above, providing improvement in the technology field of wireless communication and increasing its efficiency and performance.

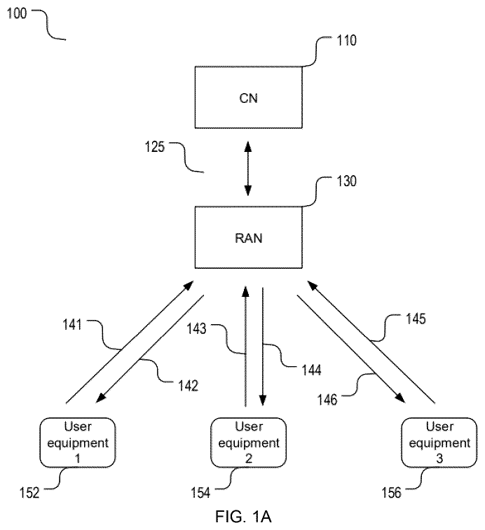

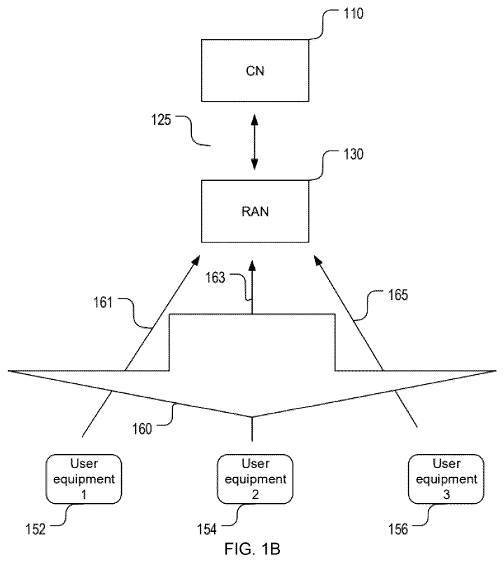

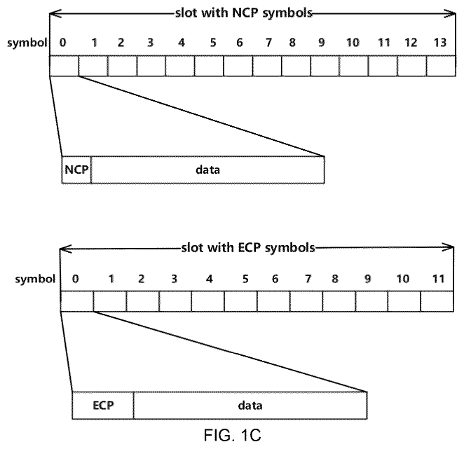

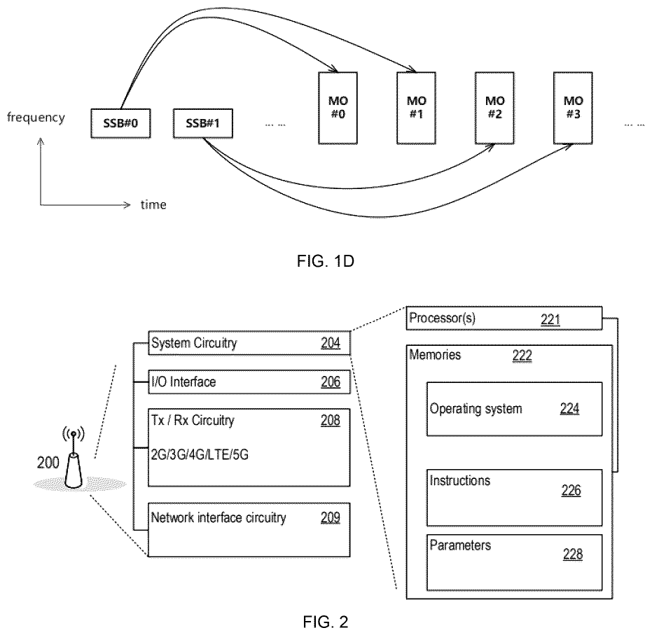

FIGS. 1A and 1B show various transmission modes for a wireless communication system 100 including a core network (CN) 110, a radio access network (RAN) 130, and one or more user equipment (UE) (152, 154, and 156). The RAN 130 may include a wireless network base station, or a NG radio access network (NG-RAN) base station or node, which may include a nodeB (NB, e.g., a gNB) in a mobile telecommunications context. In one implementation, the core network 110 may include a 5G core network (5GC), and the interface 125 may include a NG interface.

The communication between the RAN and the one or more UE may include at least one radio bearer (RB) for multicast broadcast services (MBS). UEs may use two different cast modes for RB to receive MBS data. One cast mode may be point-to-point (PTP) or unicast, another cast mode may be point-to-multipoint (PTM) or multicast or broadcast. The PTP cast mode and unicast cast mod may refer to a same cast mode. A PTP RB may be a DRB, a PTM RB may be a multicast RB or a broadcast RB. FIG. 1A shows a PTP cast mode for the one or more UE for MBS; and FIG. 1B shows a PTM cast mode for the one or more UE for MBS.

Referring to FIG. 1A, a first UE 152 (User equipment 1 152) may wirelessly receive from the RAN 130 via a PTP RB 142 and wirelessly send communication to the RAN 130 via a uplink channel 141. Likewise, a second UE 154 (User equipment 2 154) may wirelessly receive communicate from the RAN 130 via a PTP RB 144 and wirelessly send communication to the RAN 130 via a uplink channel 143; and a third UE 156 (User equipment 3 156) may wirelessly receive communicate from the RAN 130 via a PTP RB 146 and wirelessly send communication to the RAN 130 via a uplink channel 145.

Referring to FIG. 1B, the RAN 130 may wirelessly communicate to one or more UEs (152, 154, and 156) via a PTM RB 160. In one implementation, the first UE 152 may wirelessly send communication to the RAN 130 via an uplink channel 161. Likewise, the second UE 154 may wirelessly send communication to the RAN 130 via a uplink channel 163; and the third UE 156 may wirelessly send communication to the RAN 130 via a uplink channel 165.

In the wireless communication system 100 in FIGS. 1A and 1B, the RAN 130 may select which cast mode one UE uses for MBS, in order to improve high efficiency of the wireless network. The cast mode selection may depend on various types of information, for example but not limited to, a load condition for MBS, a working status of UE in a PTP cast mode or a PTM cast mode, or a cast mode interest indication of the UE.

In some implementations, ECP may be only supported under 60 kHz sub-carrier spacing (SCS). For other SCSs (for example, 15 kHz, 30 KHz, 120 KHz, 240 kHz, 480 kHz, 960 kHz, etc.), only NCP may be supported. Taking 15 kHz SCS as an example, the length of a slot is 1 millisecond (ms) no matter ECP or NCP. For a slot with NCP symbols, as shown in FIG. 1C, there are 14 symbols within a slot. For the first symbol of each 0.5 ms, i.e., the first symbol or the seventh symbol in the slot, the CP length is about 5.2 microsecond (us) (i.e., 160 sampling points). The CP length of each of the remaining symbols in the slot is about 4.7 μs (i.e., 144 sampling points). The length of data part of a symbol in the slot is 66.7 μs (i.e., 2048 sampling points). For a slot with ECP symbols, there are 12 symbols within a slot. For the each symbol in the slot, i.e., the CP length is about 16.7 μs (i.e., 512 sampling points). The length of data part of a symbol in the slot is still 66.7 μs (i.e., 2048 sampling points). Comparing with NCP, a larger CP length can resist larger multi-path delay spread and avoid inter-symbol interference in SFN transmission mode.

In some implementations, a UE may receive synchronization signal block (SSB) and system information (for example, system information block type 1 (SIB1)) to obtain the information required for cell access. The configuration information (e.g., CORESET #0 and search space #0 (may be called as type0-PDCCH common search space), which jointly determines an occasion for monitoring the SIB1 physical downlink control channel (PDCCH), that is, the monitoring occasion, MO) for monitoring SIB1 PDCCH is provided by master information block (MIB) carried on physical broadcast channel (PBCH) in the SSB. In some implementations, specifically, for a first frequency range (FR1), the CORESET #0 may be configured to include 24, 48, or 96 physical resource blocks (PRBs) in frequency domain and 2 or 3 symbols in time domain, and it needs to include SSB with twenty PRBs in frequency domain. In the time domain, the time domain position of a CORESET #0 is determined by the search space configuration associated with the CORESET #0. Further, SSB with different indexes are mapped to one or more MOs (defined via CORESET #0 and search space #0) in accordance with a specific rule. A non-limiting example is shown in FIG. 1D, wherein a SSB is mapping with two continuous MOs, e.g., SSB #0 is mapping with MO #0 and MO #1, SSB #1 is mapping with MO #2 and MO #3, etc. Further, a UE that selects a specific SSB (e.g., with index #0) may monitor the SIB1 PDCCH in corresponding MOs (e.g., MO #0 and MO #1), and may receive corresponding physical downlink shared channel (PDSCH) according to scheduling information carried in PDCCH.

In some implementations, for NR broadcast, a broadcast CFR is defined for reception of both of multicast control channel (MCCH), which may include PDCCH and PDSCH, and multicast traffic channel (MTCH), which may include PDCCH and PDSCH. The broadcast CFR may be configured as a group of continuous PRBs, and the frequency range of the CFR can equal to or larger than the bandwidth of CORESET #0/initial DL BWP. So that a UE can receive both of the NR broadcast and SSB/SIB without switching the radio frequency (RF).

In some implementations, for NR multicast, a multicast CFR may be configured via RRC signaling. The multicast CFR may be associated with an active DL BWP, and may be included in the active DL BWP, which is used for unicast reception. Thus, a UE may receive multicast and unicast without switching the active DL BWP. When the configuration information of the multicast CFR is absent, the frequency range of the multicast CFR may be same as the active DL BWP.

In some implementations, the initial DL BWP in the FR1 may be either 15 kHz or 30 kHz, under which only NCP is supported. The CFR associated with it may also be 15 kHz or 30 kHz with NCP. Similarly, when an active DL BWP is configured with 15 kHz or 30 KHz, the CP type may also be NCP, and the associated CFR for multicast may only be NCP.

FIG. 2 shows an example of electronic device 200 to implement a network base station. The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

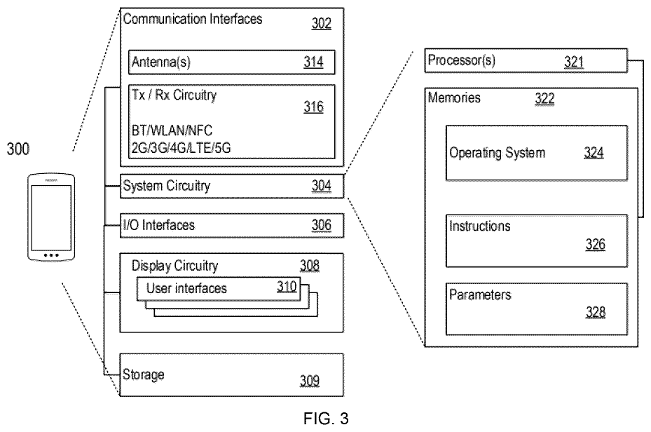

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), 5G standards, 6G standards, or any other telecommunication standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G, 6G, or other data that the UE 300 will send, or has received, through the communication interfaces 302. In various implementations, a system power for the UE 300 may be supplied by a power storage device, such as a battery or a transformer.

The present disclosure describes various embodiment for configuring extended cyclic prefix (ECP) for broadcast and/or multicast transmission, which may be implemented, partly or totally, on the network base station and/or the user equipment described above in FIGS. 2 and 3.

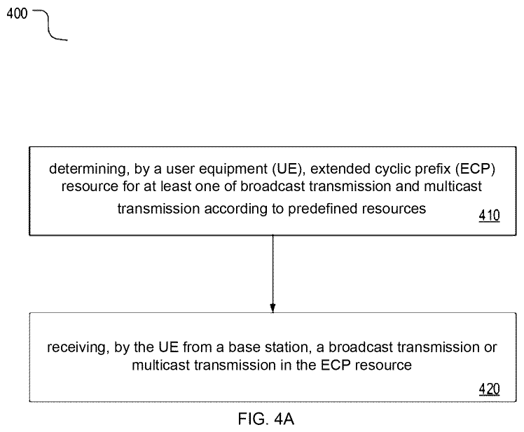

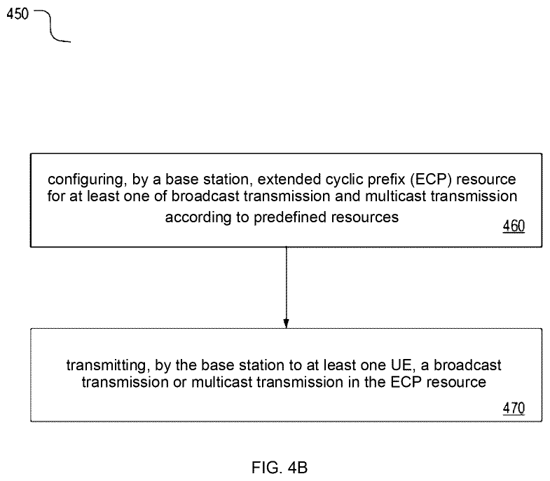

Referring to FIG. 4A, the present disclosure describes various embodiments of a method 400 for wireless communication for configuring ECP for broadcast and/or multicast transmission. The method 400 may include a portion or all of the following steps: step 410, determining, by a user equipment (UE), extended cyclic prefix (ECP) resource for at least one of broadcast transmission and multicast transmission according to predefined resources; and/or step 420, receiving, by the UE from a base station, a broadcast transmission or multicast transmission in the ECP resource.

Referring to FIG. 4B, the present disclosure describes various embodiments of a method 450 for wireless communication. The method 450 may include a portion or all of the following steps: step 460, configuring, by a base station, extended cyclic prefix (ECP) resource for at least one of broadcast transmission and multicast transmission according to predefined resources; and/or step 470, transmitting, by the base station to at least one UE, a broadcast transmission or multicast transmission in the ECP resource.

In some implementations, in addition to a portion, an entire, or any combination of the described implementation(s)/embodiment(s), the ECP resource in the time domain is determined by excluding the predefined resources in the time domain.

In some implementations, in addition to a portion, an entire, or any combination of the described implementation(s)/embodiment(s), the ECP resource comprises a same frequency range as a broadcast common frequency resource (CFR); and/or the ECP resource and normal cyclic prefix (NCP) resource are time division multiplexed (TDMed) with each other.

In some implementations, in addition to a portion, an entire, or any combination of the described implementation(s)/embodiment(s), the predefined resources comprise resources with predefined attribute or used for predefined transmission comprising at least one of the following: an uplink resource, a flexible resource configured by a radio resource control (RRC) signaling (e.g., a cell-specific frame structure configuration signaling), a synchronization signal block (SSB) resource indicated by a RRC signaling, a monitoring occasion (MO) determined according to a control resource set with index zero (CORESET #0) and a type-0 physical downlink control channel (PDCCH) common search space, a MO determined according to a CORESET #0 and a common search space configured by a system information block (SIB), a MO determined according to a common control resource set (CORESET) and a common search space configured by a SIB, and associated with at least one SSB, a slot containing a MO determined according to a CORESET #0 and a common search space configured by a SIB, a slot containing MO determined according to a CORESET #0 and a type-0 PDCCH common search space, or a slot containing MO determined according to a common CORESET and a common search space configured by a SIB, and associated with at least one SSB.

In some implementations, in addition to a portion, an entire, or any combination of the described implementation(s)/embodiment(s), in response to the ECP resource following a NCP resource in the time domain, a first symbol of the ECP resource starts a first time gap after an end of the NCP resource; and/or in response to the ECP resource being followed by a NCP resource in the time domain, the ECP resource ends no later than a second time gap before a first symbol of the NCP resource.

In some implementations, in addition to a portion, an entire, or any combination of the described implementation(s)/embodiment(s), the first time gap and the second time gap has same value.

In some implementations, in addition to a portion, an entire, or any combination of the described implementation(s)/embodiment(s), the ECP resource in the time domain is configured via a RRC signaling comprising one of the following: a period, an offset, and a duration; or a period and a bitmap corresponding to the period.

In some implementations, in addition to a portion, an entire, or any combination of the described implementation(s)/embodiment(s), the ECP resource in the time domain is further determined to be within a configured ECP window in the time domain.

In some implementations, in addition to a portion, an entire, or any combination of the described implementation(s)/embodiment(s), the ECP resource in the frequency domain is determined by excluding the predefined resources in the frequency domain; and/or the predefined resources comprise an initial downlink (DL) bandwidth part (BWP).

In some implementations, in addition to a portion, an entire, or any combination of the described implementation(s)/embodiment(s), the ECP resource comprises a same time range as a broadcast CFR; and/or the ECP resource and normal cyclic prefix (NCP) resource are frequency division multiplexed (FDMed) with each other.

In some implementations, in addition to a portion, an entire, or any combination of the described implementation(s)/embodiment(s), the ECP resource in the frequency domain is configured via a system information.

In some implementations, in addition to a portion, an entire, or any combination of the described implementation(s)/embodiment(s), the ECP resource is determined by excluding predefined resources in a time domain and a frequency domain; the ECP resource in the time domain is configured via a RRC signaling and the ECP resource in the frequency domain is determined by excluding predefined resources; the ECP resource is configured via a RRC signaling in the time domain and the frequency domain; and/or the ECP resource in the time domain is determined by excluding predefined resources and the ECP resource in the frequency domain is configured via a RRC signaling.

In some implementations, in addition to a portion, an entire, or any combination of the described implementation(s)/embodiment(s), the ECP resource in a frequency domain is determined according to a frequency range of at least one multicast common frequency resource (CFR) within a corresponding active DL BWP and a system information signaling comprising a first frequency range for the ECP resource.

In some implementations, in addition to a portion, an entire, or any combination of the described implementation(s)/embodiment(s), the ECP resource in the frequency is determined by an overlapping frequency resource between the at least one multicast CFR and the first frequency range.

In some implementations, in addition to a portion, an entire, or any combination of the described implementation(s)/embodiment(s), in response to a subcarrier spacing (SCS) of a multicast CFR within the first frequency range in the frequency domain not supporting ECP, the multicast CFP is determined to be NCP resource.

In some implementations, in addition to a portion, an entire, or any combination of the described implementation(s)/embodiment(s), a CP type of each multicast CFR is configured via an RRC signaling.

In some implementations, in addition to a portion, an entire, or any combination of the described implementation(s)/embodiment(s), in response to resources within which PDCCH MOs are configured having different CP types, the PDCCH MOs are determined as MOs for monitoring PDCCH with different CP types, respectively; and/or in response to resources within which PDCCH MOs are configured having different SCSs, the PDCCH MOs are determined as MOs for monitoring PDCCH with different SCSs, respectively.

In some implementations, in addition to a portion, an entire, or any combination of the described implementation(s)/embodiment(s), in response to a MO being within an ECP resource, a number of symbols of the MO is determined according to a configured number of symbols of a CORESET associated with the MO and a first predefined rule; and/or in response to a MO being within an ECP resource, a number of resource blocks (RBs) of the MO is determined according to a configured number of RBs of a CORESET associated with the MO and a second predefined rule.

In some implementations, in addition to a portion, an entire, or any combination of the described implementation(s)/embodiment(s), the first predefined rule comprises decreasing the configured number of symbols of the CORESET associated with the MO; and/or the second predefined rule comprises increasing the configured number of RBs of the CORESET associated with the MO.

In some implementations, in addition to a portion, an entire, or any combination of the described implementation(s)/embodiment(s), in response to a transmission with NCP overlapping with the ECP resource, the transmission is determined to perform one of the following: being dropped from transmission, being punctured for transmission in resource without the overlapping portion, or rate matching around the overlapping portion for transmission.

In some implementations, in addition to a portion, an entire, or any combination of the described implementation(s)/embodiment(s), in response to a transmission with NCP overlapping with the ECP resource, the transmission is determined to change the scheduled resource's frequency and/or time location for the transmission according to a third predefined rule.

In some implementations, in addition to a portion, an entire, or any combination of the described implementation(s)/embodiment(s), the third predefined rule comprises changing the scheduled resource's frequency and/or time location for the transmission based on a frequency and/or time offset to avoid overlapping with the ECP resource.

In some implementations, in addition to a portion, an entire, or any combination of the described implementation(s)/embodiment(s), in response to a transmission with ECP overlapping with the NCP resource, the transmission is determined to change the scheduled resource's frequency and/or time location for the transmission according to a fourth predefined rule.

In some implementations, in addition to a portion, an entire, or any combination of the described implementation(s)/embodiment(s), the fourth predefined rule comprises changing the scheduled resource's frequency and/or time location for the transmission based on a frequency and/or time offset to avoid overlapping with the NCP resource.

In some implementations, in addition to a portion, an entire, or any combination of the described implementation(s)/embodiment(s), in response to a transmission with NCP located within the ECP resource, the time domain position of a demodulation reference signal (DMRS) for the transmission is determined according to a rule for determining a DMRS position of a transmission in a NCP resource.

In some implementations, in addition to a portion, an entire, or any combination of the described implementation(s)/embodiment(s), in response to a transmission with ECP located with the NCP resource, the time domain position of a demodulation reference signal (DMRS) for the transmission is determined according to a rule for determining a DMRS position of a transmission in a ECP resource.

The present disclosure describes various embodiments on how to configure or define the resource for ECP for broadcast and/or multicast transmission, as well as, configure PDCCH monitoring information sharing by among different numerologies, e.g., ECP and NCP; on how to transmit an information across time domain resource with different CP types or different SCSs. In various embodiments, the methods on type 1 feedback codebook generation under the case that there are both ECP resource and NCP resource in one slot are described. The present disclosure is associated with the benefits that system resource for introducing ECP resource into NCP BWP or mixing resource with different numerologies may be effectively utilized.

### Embodiment Set I

The present disclosure describes various embodiments for configuring ECP resource for broadcast transmission.

In an embodiment of a first method (Method 1), resource with different CP types are time division multiplexed (TDMed) with each other; and/or the frequency domain range of the ECP resource is same as that of the broadcast CFR.

In some implementations, the ECP resource in the time domain is determined by excluding some time domain resource with predefined attribute or used for predefined transmission. For example, at least one of predefined attribute or predefined transmission can be defined as following: UL resource, flexible resource configured by cell-specific frame structure configuration signaling, SSB resource indicated by RRC signaling, CORESET #0 associated with type0-PDCCH common search space, CORESET #0 associated with a common search space configured by SIB1, MOs determined according to a common CORESET and a common search space configured by SIB1, and the MOs associated with at least one SSB, slots of CORESET #0 associated with a common search space configured by SIB1, slots of CORESET #0 associated with type0-PDCCH common search space, slots of MOs, which are determined according to a common CORESET and a common search space configured by SIB1, and associated with at least one SSB.

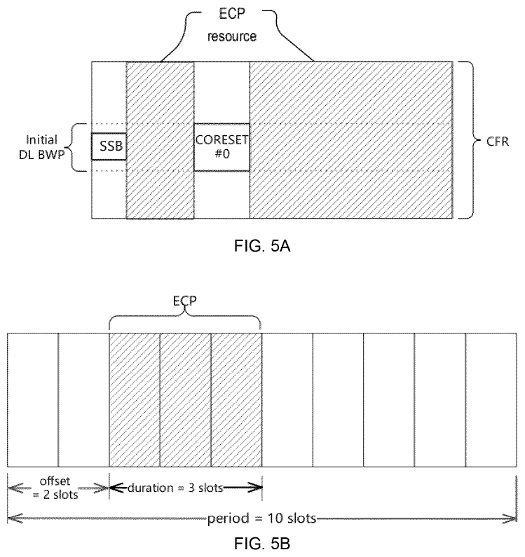

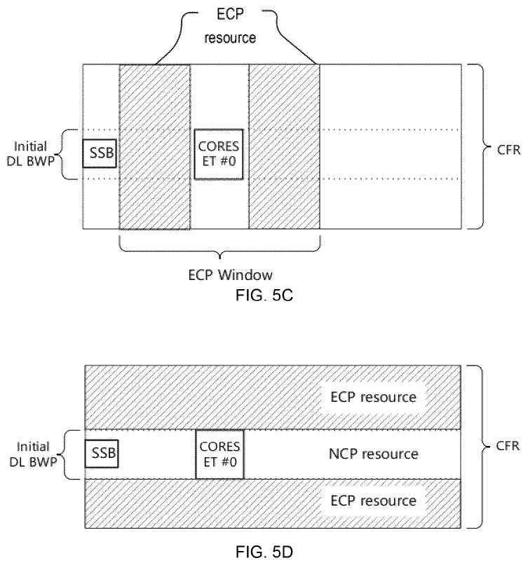

FIG. 5A shows a non-limiting example, wherein the ECP resource is determined by excluding the SSB resource and CORESET #0 resource. The ECP resource in the frequency domain has the same frequency range as the CFR in the frequency domain; and the ECP resource in the time domain is TDMed with other resource with NCP.

In some implementations, a first time domain gap (T1) is defined for switching from NCP to ECP. When an ECP resource follows a NCP resource, the ECP resource may start T1 after the end of the NCP resource, i.e., a first symbol of the ECP resource starts T1 after a last symbol of the NCP resource. The first time domain gap T1 may be used by a UE for switching the reception mode from NCP to ECP, or used by a gNB for switching the transmission mode from NCP to ECP. Here, a “first” symbol of the ECP resource may refer to an “earliest” symbol of the ECP resource.

In some implementations, a second time domain gap T2 is defined for switching from ECP to NCP. When an ECP resource is followed by a NCP resource, the ECP resource ends no later than T2 before the NCP resource starts, i.e., a last symbol of the ECP resource ends T2 earlier than (or more than T2 earlier than) a starting of a first symbol of the NCP resource. That is, the second time domain gap T2 will be used by a UE for switching the reception mode from ECP to NCP, or used by a gNB for switching the transmission mode from ECP to NCP. Here, a “first” symbol of the NCP resource may refer to an “earliest” symbol of the NCP resource.

In some implementations, the first time domain gap T1 may equal to the second time domain gap T2. That is, only one time domain gap T is defined for switching between NCP and ECP.

In some implementations, the ECP resource are configured via RRC signaling, e.g, SIB1. For example, a time domain resource is configured by using period, offset and duration. As shown in FIG. 5B, the duration of ECP is 3 slots, and the 3 slots ECP resource may occur every 10 slots, i.e., the period is 10 slots. The ECP resource starts from the third slots of each period (i.e., offset). In some embodiments, the time domain resource can also be configured in terms of at least one of, frame, sub-frame, half frame, millisecond (ms), etc. In some embodiments, the period of the time domain resource equals to the period of a frame structure. In some embodiments, the time domain resource is configured within a flexible resource.

In some implementations, the frequency domain range of the ECP resource equals to the bandwidth of CFR.

In some implementations, the time domain resource or pattern of ECP resource may be configure by a period and a bitmap within the period. For example, the period is 10 slots, and a bitmap with 10 bits are further used to indicate which slots are ECP slots. That is, each bit of the bitmap indicates the CP type of one slot of the period. The mapping relationship between bits in the bitmap and the slots within the period are predefined. For example, the first bit is mapping with the first slot within the period. And the second bit is mapping with the second slot within the period. In the example shown in FIG. 5B, period is configured as 10 slots, and a bitmap with ‘00111 00000’ is used for indicating the CP type of each slot in the period, wherein “1” indicates ECP and “0” indicates NCP. Here, a “first” bit of the bitmap may refer to a most left/significant bit of the bitmap, and a “first” slot within the period may refer to an “earliest” slot within the period.

In some implementations, the configured ECP resource may exclude some time domain resource with predefined attribute or used for predefined transmission (for example, as defined above).

In some implementations as shown in FIG. 5C, when there are resource should be excluded from an ECP window, the time domain gap should also be excluded from the ECP window.

In another embodiment (Method 2), resource with different CP types may be frequency division multiplexed (FDMed) with each other. For a non-limiting example, an ECP CFR may be defined, and there may be at most two CFR for broadcast reception, one is ECP CFR and another is NCP CFR.

In some implementations, as shown in FIG. 5D, the frequency range of the ECP CFR is defined by excluding the initial DL BWP from the CFR configured in the system information. For example, the initial DL BWP may be CORESET #0 defined initial DL BWP, i.e., the bandwidth of the initial DL BWP equals to that of CORESET #0. In some implementations, the frequency range of the initial DL BWP can be configured via SIB1.

In some implementations, the frequency range of the ECP CFR is configured via system information. For example, the frequency range of the ECP CFR may be configured based on a frequency reference point (e.g., point A or the lowest resource element (RE) or resource block (RB) of NCP CFR).

In some implementations, the frequency range of the ECP CFR may be outside the initial DL BWP.

In some implementations, a frequency guard band is defined between the ECP and the NCP resource.

In another embodiment (Method 3), the ECP resource is defined by excluding some resource or via signaling in both of time domain and frequency domain.

In some implementations, as shown in FIG. 5E, some resource with predefined attribute or used for predefined transmission are excluded from the ECP resource in the time domain, and the frequency range of the initial DL BWP is excluded from ECP resource in the frequency domain. Then, the remaining resource are defined as ECP resource.

In some implementations, the time domain resource of ECP resource are configured via signaling, and the frequency domain resource of ECP resource are defined by excluding some predefined resource, e.g., initial DL BWP.

In some implementations, both of the time domain resource and frequency domain resource of ECP resource are configured via signaling. In some implementations, the configured ECP resource should exclude some predefined resource in at least one of time domain or frequency domain.

In some implementations, the time domain resource of ECP resource are defined by excluding some predefined resource, and the frequency domain resource of ECP resource are configured via signaling.

Various embodiments provide methods for configuring or defining ECP resources for multicast and/or broadcast transmission, improving effective utilization of system resource.

### Embodiment Set II

Various embodiments in the present disclosure describe methods for configuring ECP resource for multicast transmission.

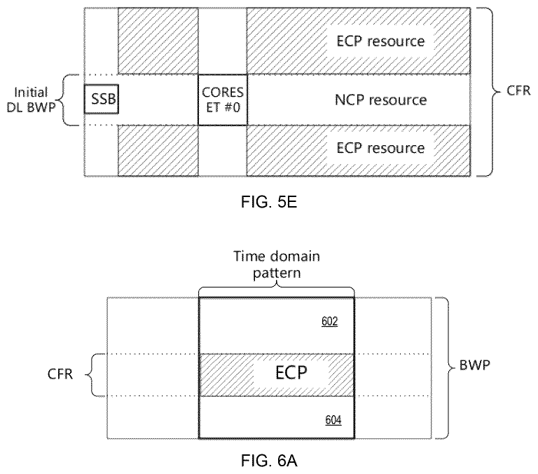

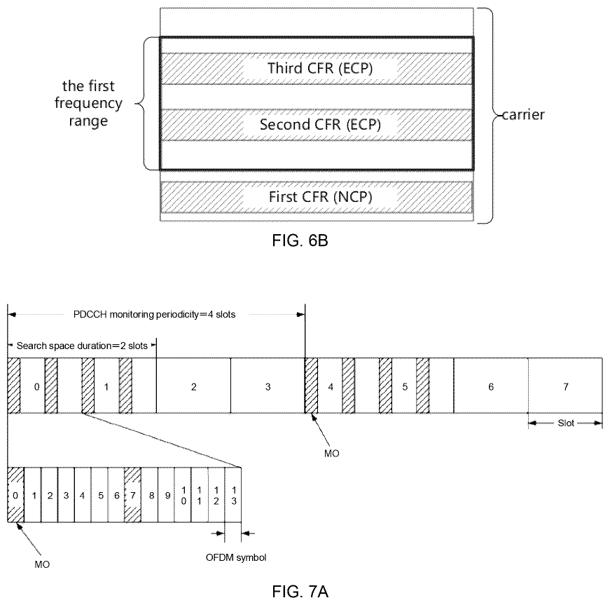

In some implementations, as shown in FIG. 6A, the multicast CFR may be configured within its associated active DL BWP. A UE may be configured with more than one DL BWPs (e.g., a UE may be configured with 4 DL BWPs), and only one of them may be activated at a time. For one configured DL BWP, at most one CFR may be configured for multicast transmission. So more than one CFR may be configured for a UE, but only the one associated with the active DL BWP may be used for receiving the multicast service at this time. When the active DL BWP switches to another one, the CFR may switch accordingly.

In some implementations, for supporting multicast transmission with ECP, a time domain resource and/or a time domain pattern may be configured as ECP resource. The frequency range of the ECP resource may equal to the bandwidth of the CFR.

In some implementations, the subcarrier spacing of a CFR and active DL BWP associated with the CFR may be same, and the CP type may be different. In some implementations, the CP type of active DL BWP may only be NCP. The CP type of the associated CFR may be at least one of ECP and NCP.

In some implementations, the resource (602 and 604 in FIG. 6A) within the active DL BWP and FDMed with the ECP resource may be considered as reserved resource, which is not used for transmitting data. In some other implementations, this resource may also be used for data transmission with NCP.

The present disclosure describes various ways for configuring the frequency range of ECP resource.

In some implementations, a cell specific signaling, e.g., signaling in system information, may be used for configuring a first frequency range for ECP resource. Further, the intersection set of the frequency domain range of the CFR and the first frequency range is defined as an ECP frequency resource.

For a non-limiting example shown in FIG. 6B, there are three CFRs within a carrier which are configured for a UE, i.e., the first CFR, the second CFR and the third CFR. The first frequency range may be configured within the carrier as shown in the box with thicker lines. The second CFR and the third CFR are located within the first frequency range, i.e., the intersection set of CFR and the first frequency range is the second CFR and the third CFR. Therefore, the frequency range of ECP resource includes the second CFR and the third CFR; and for the first CFR, it is a NCP resource, i.e., a CFR used for multicast transmission with NCP.

In some implementations, not all subcarrier spacings SCSs) support ECP.

Therefore, when the SCS of a CFR within the first frequency range does not support ECP, it may be defined as a NCP resource.

In some implementations, the CP type is configured per CFR. More specifically, the CP type of a CFR may be configured independently of the active DL BWP associated with the CFR.

In some implementations, for unicast transmission within an active DL BWP with 15 kHz, only NCP may be supported. There is no need to indicate the CP type for the active DL BWP, and it is NCP by default. Further, the CP type of the CFR associated with the active DL BWP may be configured. When the CP type of the CFR is configured as ECP, it means that all the resource within the CFR is ECP. Alternatively, it means that at least part of resource within the CFR is ECP, for example, some time domain resources of the CFR are ECP and other time domain resources are NCP.

In some implementations, when the CP type of the CFR is configured as NCP, it means that there is no ECP resource in the CFR or all the resource within the CFR is ECP resource. In some implementations, a time domain pattern of ECP resource may be configured for the CFR associated with the active DL BWP. When the time domain pattern is absent, it means that all the resource of the CFR is NCP. Alternatively, it means that the CP type of the CFR is same as that of the associated DL BWP.

In some implementations, both ECP and NCP may be supported for unicast transmission under a first SCS, e.g., 60 KHz. Then, there may be an indication of CP type for the active DL BWP. The CP type for the CFR associated with the active DL BWP may follow that for the active DL BWP.

In some implementations, only one type of CP may be support for unicast transmission under a second SCS, e.g., 15 kHz, or there is an indication of CP type for the active DL BWP. There may be another signaling for indicating whether the CP type is same as that of active DL BWP. For example, when the signaling is present, it means that the CP type of CFR is different from that of the associated active DL BWP; and/or when the signaling is absent, it means that the CP type of the CFR is same with that of the associated active DL BWP. In some other examples, the signaling may have two values: one value represents that the CP type of CFR is different from that of the associated active DL BWP; and/or another value represents that the CP type of the CFR is same with that of the associated active DL BWP. In some other examples, the signaling may have two values: one value represents that the CP type of CFR is ECP; and/or another value represents that the CP type of the CFR is NCP.

In some implementations, for a CFR with ECP resource, a time domain pattern may be configured for indicating which time domain resource are ECP, and which time domain resource are NCP. In some implementations, the configuration is only applicable to the resources configured as flexible resources by the semi-static frame structure configuration signaling. In some implementations, the frame structure may be further configured for the ECP resource.

Various embodiments in the present disclosure provide some methods for configuring or defining resources for ECP for multicast transmission, improving effective utilization of system resource.

### Embodiment Set III

Various embodiments in the present disclosure describe methods for configuring PDCCH monitoring information sharing by among different numerologies, e.g., ECP and NCP.

In some implementations, the PDCCH monitoring information is defined by control resource set (CORESET) and search space set. One or more search space sets are configured by the network for a UE. The configuration parameters of a search space set include one, a portion, or all of the following: search space index, associated CORESET index, PDCCH monitoring periodicity and offset, search space duration, PDCCH monitoring pattern within a slot, search space type, etc. In general, there are two types of search space, UE-specific search space (USS) and common search space (CSS). A search space type may also indicate the downlink control information (DCI) formats that a UE monitors. A search space set is associated with a CORESET. PDCCH monitoring periodicity and offset indicates the slots on which a UE needs to monitor PDCCH. According to a search space set configuration and the associated CORESET configuration, a UE may be configured to monitor corresponding PDCCH with DCI formats indicated by the search space type on the resources indicated by the CORESET in the slots indicated by the PDCCH monitoring periodicity and offset.

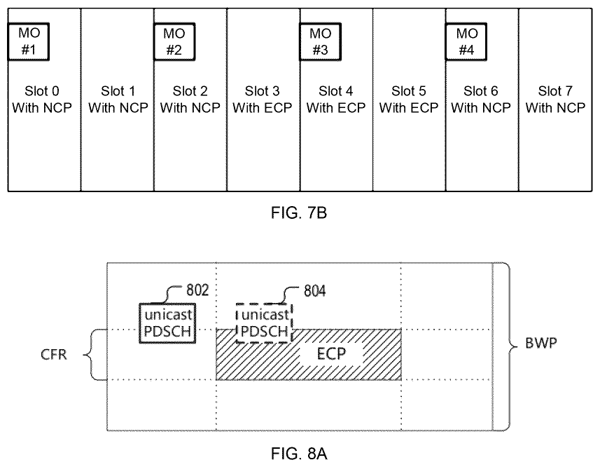

In some implementations, FIG. 7A shows a diagram illustrating an example of configuration of PDCCH monitoring occasion (MO). Eight slots are illustrated overall (denoted by slot 0˜7). PDCCH monitoring periodicity is 4 slots and offset is 0. The search space duration is 2 slots. It is configured that 2 PDCCH monitoring occasions (MOs) in a slot. Therefore, there may be totally 4 MOs within one PDCCH monitoring period. On each of MOs, there may be one resource configured by CORESET for UE to monitor PDCCH.

In wireless communication system, there are one or more PDCCH candidates in one MO. Each PDCCH candidate have a PDCCH candidate index. A PDCCH consists of one or more control-channel elements (CCEs). Each CCE have a CCE index.

In some implementations, the different resource within one BWP may be defined as different CP types or different SCSs. The MOs configured by a same configuration of search space set and CORESET may be located within resource different CP types or different SCSs, and they may also be defined as MO for monitoring PDCCH with different CP types or different SCSs. A non-limiting example is shown in FIG. 7B, wherein there are 8 slots (slot 0˜7), and slot 3˜5 are ECP resource. The monitoring period is 2 slots, and 4 MOs (MO #1˜MO #4) are located within slot 0, 2, 4, 6, respectively. The MO #3 is located within ECP resource, and it is an ECP MO for monitoring PDCCH with ECP. The MO #1, MO #2 and MO #4 are NCP MO, and are used for monitoring PDCCH with NCP.

In some implementations, the number of symbols (twelve, namely symbol #0˜symbol #11) in the ECP slot is two less than the number of symbols (fourteen, namely symbol #0˜symbol #13) in the NCP slot; and when the start symbol of MO is configured according to the NCP slot, the MO may exceed the range of the ECP slot. For a non-limiting example, when the parameter ‘PDCCH monitoring pattern within a slot’ is set to {0000000 0000100}, that is, the start symbol index is symbol #11, and when duration of the associated CORESET is greater than one (e.g. 2), the MO may occupy symbol #11 and symbol #12, exceeding the range of the symbols in the ECP slot. In some implementations, such MO with any symbol outside the ECP slot range are defined as invalid. In other words, the UE will not monitor this PDCCH in the ECP slot. In some other implementations, a symbol of MO that is beyond a range of the ECP slot is removed, so that remaining symbols form one MO. In the foregoing example, the MO in the ECP slot are reduced to one symbol, that is, symbol #11. In some other implementations, the UE does not expect the configured MO to exceed the symbol range of the ECP slot.

In some implementations, when a MO located within an ECP slot, the number of symbols of MO, i.e., duration of the CORESET, may be changed according to a predefined rule. For a non-limiting example, when the configured duration of the CORESET is 3 symbols, and when a MO is located within ECP slot, the number of symbols may be changed from 3 to 2.

In some implementations, when a MO located within an ECP slot, the number of RBs of MO, i.e., number of RBs of the CORESET, may be changed according to a predefined rule. For a non-limiting example, when the configured number of RBs of the CORESET is 48 RBs, and when a MO is located within ECP slot, the number of RBs may be changed from 48 to 96.

Various embodiments provide methods for configuring PDCCH monitoring information sharing by among different numerologies, e.g., ECP and NCP, improving effective utilization of system resource.

### Embodiment Set IV

Various embodiments in the present disclosure describe methods for how to transmit an information across time domain resource with different CP types or different SCSs.

In some implementations, for some transmissions, such as, PDSCH repetitions, SPS PDSCH, Multi-PDSCH scheduled by a single DCI, transmission block over multiple slots (TBoMS), and/or periodic/semi-persistent CSI-RS, different types of resources may be occupied by them.

In some implementations, taking PDSCH repetitions as an example, a repetition factor may be configured via RRC signaling or indicated by a DCI. The PDSCH may be transmitted repeatedly across multiple slots. Part of the slots may be slots with a first CP type, e.g., NCP, while other slots may be slots with a second CP type, e.g., ECP. Some rules may be defined on how to transmit a same information across multiple slots with different slot types, e.g., different CP types or different SCSs.

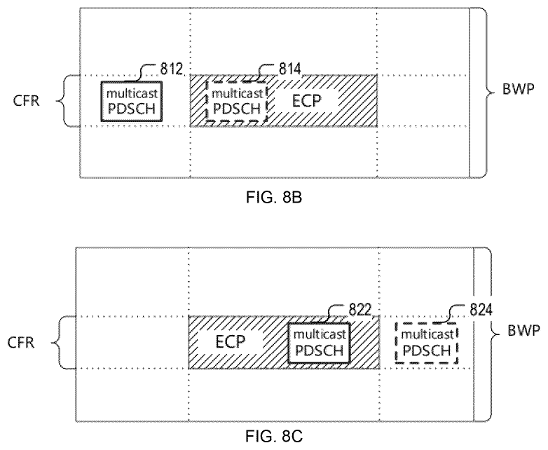

In some implementations, as shown in FIG. 8A, unicast (e.g., 802 and 804) does not support ECP, that is, BWP is configured or defined as NCP resource, and some time-domain resources of CFR associated with BWP are configured as ECP resource. When unicast transmission (such as SPS PDSCH, PDSCH repetition, and TBoMS) falls into the slot in which the ECP resource exists (e.g., a portion of 804 overlapping with a portion of ECP resources), it may not be ensured that a complete PDSCH is sent. In some implementations, the dashed line unicast transmission is drop, i.e., the whole unicast PDSCH 804 is dropped, and may not be transmitted. In some implementations, the dashed line unicast transmission may be punctured, i.e., the overlapping portion of the unicast 804 is punctured and may not be transmitted. In some implementations, the dashed line unicast transmission may be rate matched around ECP resource, i.e., the information in original unicast PDSCH is encoded by a higher coding rate to fit into the unicast PDSCH portion not-overlapping with the ECP. In some implementations, the frequency domain location may be changed by using a predefined rule for transmission. For a non-limiting example, the frequency domain location of the unicast transmission may be changed based on a frequency domain offset to not overlap with the resource with a first CP type (e.g., ECP), or the FDRA (Frequency Domain Resource Allocation) field is re-interpreted for indicating a resource without overlapping with the resource with a first CP type (e.g., ECP). In some implementations, the time domain location may be changed by using a predefined rule for transmission. For a non-limiting example, the time domain location of the unicast transmission may be changed based on a time domain offset to not overlap with the ECP resource, or the TDRA (Time Domain Resource Allocation) field is re-interpreted for indicating a resource without overlapping with the ECP resource.

In some implementations, as shown in FIG. 8B, multicast transmission (812 and 814) are scheduled or configured across different slot types, e.g., CP types or SCS. The first transmission (812) is located within a NCP slot, and the subsequent transmission (with dashed line, 814) is located within an ECP slot. In some implementations, the entire subsequent transmission (814) may be dropped. In some implementations, in the subsequent transmission (814), the part of transmission which exceeds the range of ECP slot may be dropped, i.e., the part of transmission exceeding the range of ECP slot may be punctured. In a non-limiting example, more specifically, a time domain resource allocation is 7 symbols, i.e., from symbol #7 to symbol #13, the encoding may base on configured resource, i.e., 7 symbols, and the mapping may base on the available resource, i.e., 5 symbols, from symbol #7 to symbol #11. In some implementations, for the subsequent transmission (814), the transmission may be made in a rate matching manner. That is, the encoding and mapping may base on the available resource within the ECP slot.

In some implementations, the time domain position of DMRS of the scheduled or configured transmission may follow the rule of a first CP type, e.g., NCP, even when the actual transmission is in a slot with a second CP type, e.g., ECP.

In some implementations, the time domain position of DMRS of the scheduled or configured transmission may follow the rule of certain CP type which it is located.

In some implementations, a UE may determine, according to a capability of the UE, whether to receive the transmission of the slot with a different CP type, e.g., ECP.

In some implementations, a gNB may configure to a UE on whether to receive the transmission in the slot with a different CP type from that of the first slot which the transmission located. Alternatively, the gNB may configure to a UE on whether it transmits the transmission in the slot with a different CP type from that of the first slot which the transmission located.

In some implementations, as shown in FIG. 8C, multicast transmission (822 and 824) are scheduled or configured across different slot types, e.g., CP types or SCS. The first transmission (822) is located within a slot with a first CP type, e.g., ECP; and the subsequent transmission (824) is located within a slot with a second CP type, e.g., NCP. In some implementations, the subsequent transmission which is located within the slot a second CP type may be dropped.

In some implementations, the time domain position of DMRS of the scheduled or configured transmission may follow the rule of a first CP type, even if the actual transmission is in the slot with a second CP type. In some examples, the time domain position of DMRS of the scheduled or configured transmission may follow the rule of certain CP type which it is located.

In some implementations, a UE may determine, according to a capability of the UE, whether to receive the transmission of the NCP slot.

In some implementations, a gNB may configure to a UE on whether to receive the transmission of the NCP slot. Alternatively, the gNB may configure to UE on whether it transmits the transmission of the NCP slot.

Various embodiments provide methods for transmitting an information across time domain resource with different CP types or different SCSs, improving effective utilization of system resource.

### Embodiment Set V

Various embodiments in the present disclosure describe methods for feedback codebook generation.

In some implementations, for type 1 feedback codebook generation, a quantity of feedback bits for one slot depends on a quantity of start and length indicator value (SLIV) group, that is, one SLIV group corresponds to one or more feedback bits. The SLIV groups are divided based on a configured or default time domain resource allocation list or table. Specifically, the time domain resource allocation list or table includes all possible time domain resource allocation, i.e., occasions for candidate PDSCH reception, and a current time domain resource allocation may be indicated from the time domain resource allocation list via a TDRA field in the scheduling DCI. In an existing system, all the occasions for candidate PDSCH reception may be divided into one or more SLIV group according to a predefined rule.

In some implementations, for a non-limiting example, a set which contains all the occasions for candidate PDSCH reception may be defined by a portion or all of the following steps.

Step 1: A first occasion with a smallest last OFDM symbol is selected from the set. Any other occasions (e.g., second occasions) with a start OFDM symbol no later than the last OFDM symbol of the first occasion may be further selected, i.e., all of the second occasion are overlapping with the first occasion. Then, the first occasion and the second occasions may form a first SLIV group.

Step 2: Excluding the first occasion and the second occasions from the set.

Step 3: repeating Step 1 for selecting another first occasion and the second occasions overlapping with the another first occasion from the remaining occasions in the set after Step 2. Then, a second SLIV group is formed.

Step 4: repeating Step 2 and Step 3 until the set is empty.

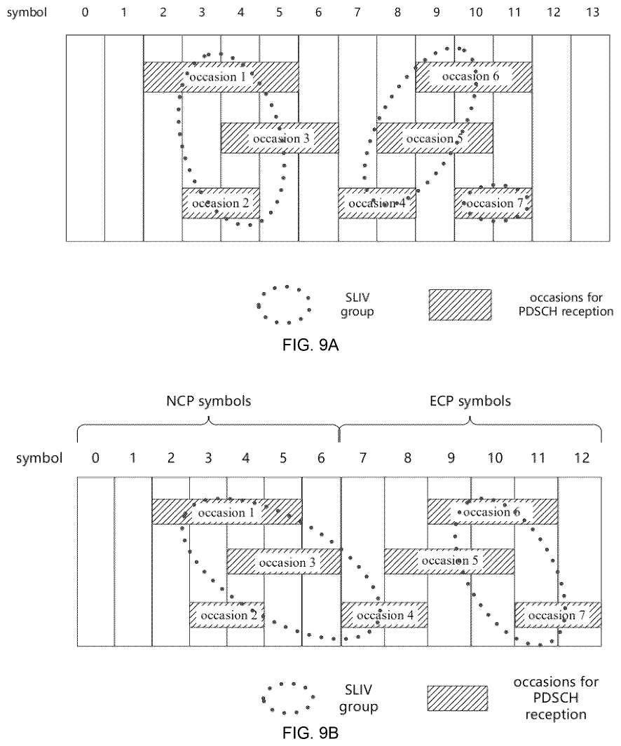

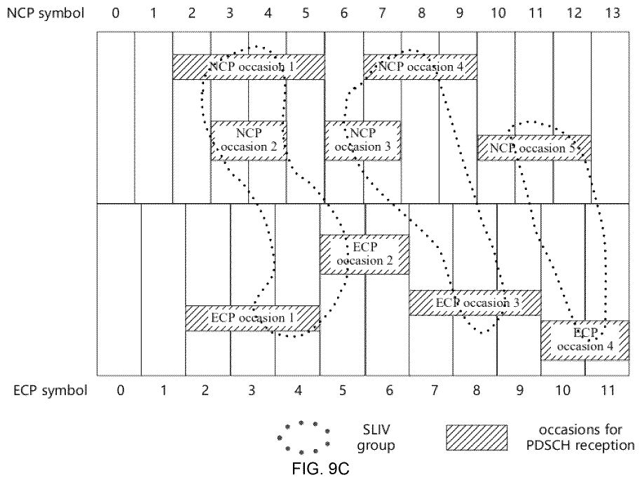

A non-limiting example is shown in FIG. 9A, wherein there is a slot with 14 NCP symbols. A set with seven occasions for PDSCH reception are defined according to the time domain resource allocation list or table. Occasion 2 is selected as it has a smallest last OFDM symbol, i.e., symbol 4. Occasion 1 and occasion 3 are further selected as the start symbol (symbol 2 and symbol 4) of each of them is no later than the last OFDM symbol of occasion 2. Occasion 1, occasion 2 and occasion 3 form a first SLIV group. Excluding the above occasions (1, 2, 3) from the set, and repeating the above steps. In some implementations, occasion 4, 5, 6 form a second SLIV group, and occasion 7 forms a third SLIV group.

In some implementations, for a UE that does not support FDM reception of PDSCH transmission, a maximum of one PDSCH may be received in the SLIV group, and therefore the SLIV group is corresponding to one feedback bit. For example as shown in FIG. 9A, there are 3 bits required. For a UE that supports FDM reception of PDSCH transmission, a quantity of feedback bits corresponding to one SLIV group is determined according to a capability of the UE, that is, according to a maximum quantity of FDMed PDSCHs that can be received by the UE.

In some implementations, there are both ECP resource and NCP resource. They are either FDMed or TDMed with each other. Considering that a switching time, for example, N symbols, is required between receiving of the ECP PDSCH by a UE and receiving of the NCP PDSCH by the UE. The switching time can be defined in a number of either ECP or NCP symbols. Alternatively, the switching time may be defined as an absolute time interval. Therefore, the foregoing switching time needs to be considered when the type 1 feedback codebook is generated and the SLIV group is divided.

In some implementations, a set may be defined to contain all the occasions for candidate PDSCH reception, including ECP occasions and NCP occasions.

Step 1: A first occasion with a smallest last OFDM symbol is selected from the set. When the smallest last OFDM symbol has a symbol index ‘M’, the second occasions may be further selected as following: for any other occasion having a different CP type with the first occasion, when it has a start OFDM symbol no later than a symbol with index ‘M+N’, it may be further selected; and/or for any other occasion having a same CP type with the first occasion, when it has a start OFDM symbol no later than a symbol with index ‘M+N’, it may be further selected.

In some implementations, the first occasion and the second occasions may form a first SLIV group.

Step 2: Excluding the first occasion and the second occasions from the set.

Step 3: repeating Step 1 for selecting another first occasion and the second occasions from the remaining occasions in the set after Step 2. Then, a second SLIV group is formed.

Step 4: repeating Step 2 and Step 3 until the set is empty.

A non-limiting example is shown in FIG. 9B, wherein NCP resource and ECP resource are TDMed with each other. That is, the first seven symbols of a slot are NCP symbols. The remaining resource is configured as six ECP symbols. For the NCP symbols, there are three occasions, i.e., occasion 1, 2, 3. For the ECP symbols, there are four occasions, i.e., occasion 4˜7. Occasions with different CP types may have a separate time domain resource allocation list or table. When the switching time is N=3 in NCP symbols, occasion 2 is selected firstly. Occasion 1, 3 and 4 may be further selected. Wherein, occasion 4 has a different CP type from occasion 2, and it is no later than symbol 7 (M+N=4+3=7), so it belongs to a same SLIV group with occasion 2. Occasion 5˜7 form another SLIV group.

Another non-limiting example is shown in FIG. 9C, wherein NCP resource and ECP resource are FDMed with each other. There may be five occasions, i.e., NCP occasion 1˜5, for PDSCH reception in NCP resource; and there may be four occasions, i.e., ECP occasion 1˜4, for PDSCH reception in ECP resource. The NCP occasions and ECP occasions may form a set for PDSCH reception. In some implementations, the switching time, N, is 3 symbols in NCP.

In some implementations, NCP occasion 2 with the smallest last symbol (symbol 4 in NCP) is selected firstly. Then, NCP occasion 1, ECP occasion 1 and ECP occasion 2 are further selected for forming the first SLIV group. Excluding the above occasions (NCP occasion 1, NCP occasion 2, ECP occasion 1 and ECP occasion 2) from the set, the above method may be performed for the remaining occasions. The NCP occasion 3, NCP occasion 4 and ECP occasion 3 form a second SLIV group. The NCP occasion 5 and ECP occasion 4 form a third SLIV group.

Various embodiments provide methods for type 1 feedback codebook generation under the case that there are both ECP resource and NCP resource in one slot, improving effective utilization of system resource.

The present disclosure describes methods, apparatus, and computer-readable medium for wireless communication. The present disclosure addressed the issues with configuring extended cyclic prefix (ECP) for broadcast and/or multicast transmission. The methods, devices, and computer-readable medium described in the present disclosure may facilitate the performance of wireless communication, thus improving efficiency and overall performance. The methods, devices, and computer-readable medium described in the present disclosure may improves the overall efficiency of the wireless communication systems.

In some other embodiments, a computer-readable medium comprising instructions which, when executed by a computer, cause the computer to carry out the above methods. The computer-readable medium may be referred as non-transitory computer-readable media (CRM) that stores data for extended periods such as a flash drive or compact disk (CD), or for short periods in the presence of power such as a memory device or random access memory (RAM). In some embodiments, computer-readable instructions may be included in a software, which is embodied in one or more tangible, non-transitory, computer-readable media. Such non-transitory computer-readable media can be media associated with user-accessible mass storage as well as certain short-duration storage that are of non-transitory nature, such as internal mass storage or ROM. The software implementing various embodiments of the present disclosure can be stored in such devices and executed by a processor (or processing circuitry). A computer-readable medium can include one or more memory devices or chips, according to particular needs. The software can cause the processor (including CPU, GPU, FPGA, and the like) to execute particular processes or particular parts of particular processes described herein, including defining data structures stored in RAM and modifying such data structures according to the processes defined by the software.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments, for non-limiting examples, a portion from one or more embodiment may be combined with another portion of other embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

What is claimed is:

1. A method for wireless communication, comprising:
determining, by a user equipment (UE), extended cyclic prefix (ECP) resource for at least one of broadcast transmission and multicast transmission according to predefined resources; and
receiving, by the UE from a base station, a broadcast transmission or multicast transmission in the ECP resource.

2. (canceled)

3. The method according claim 1, wherein:
the ECP resource in the time domain is determined by excluding the predefined resources in the time domain.

4. The method according to claim 3, wherein:
the ECP resource comprises a same frequency range as a broadcast common frequency resource (CFR); or
the ECP resource and normal cyclic prefix (NCP) resource are time division multiplexed (TDMed) with each other.

5. The method according to claim 3, wherein:
the predefined resources comprise resources with predefined attribute or used for predefined transmission comprising at least one of the following: an uplink resource, a flexible resource configured by a radio resource control (RRC) signaling, a synchronization signal block (SSB) resource indicated by a RRC signaling, a monitoring occasion (MO) determined according to a control resource set with index zero (CORESET #0) and a type-0 physical downlink control channel (PDCCH) common search space, a MO determined according to a CORESET #0 and a common search space configured by a system information block (SIB), a MO determined according to a common control resource set (CORESET) and a common search space configured by a SIB, and associated with at least one SSB, a slot containing a MO determined according to a CORESET #0 and a common search space configured by a SIB, a slot containing MO determined according to a CORESET #0 and a type-0 PDCCH common search space, or a slot containing MO determined according to a common CORESET and a common search space configured by a SIB, and associated with at least one SSB.

6. The method according to claim 3, wherein:
in response to the ECP resource following a NCP resource in the time domain, a first symbol of the ECP resource starts a first time gap after an end of the NCP resource; or
in response to the ECP resource being followed by a NCP resource in the time domain, the ECP resource ends no later than a second time gap before a first symbol of the NCP resource, wherein the first time gap and the second time gap has same value.

7. (canceled)

8. The method according to claim 3, wherein:
the ECP resource in the time domain is configured via a RRC signaling comprising one of the following: a period, an offset, and a duration; or a period and a bitmap corresponding to the period.

9. The method according to claim 3, wherein:
the ECP resource in the time domain is further determined to be within a configured ECP window in the time domain.

10. The method according to claim 1, wherein:
the ECP resource in the frequency domain is determined by excluding the predefined resources in the frequency domain; and
the predefined resources comprise an initial downlink (DL) bandwidth part (BWP).

11. The method according to claim 10, wherein:
the ECP resource comprises a same time range as a broadcast CFR; or
the ECP resource and normal cyclic prefix (NCP) resource are frequency division multiplexed (FDMed) with each other; or
the ECP resource in the frequency domain is configured via a system information.

12. (canceled)

13. The method according to claim 1, wherein:
the ECP resource is determined by excluding predefined resources in a time domain and a frequency domain;
the ECP resource in the time domain is configured via a RRC signaling and the ECP resource in the frequency domain is determined by excluding predefined resources;
the ECP resource is configured via a RRC signaling in the time domain and the frequency domain; or
the ECP resource in the time domain is determined by excluding predefined resources and the ECP resource in the frequency domain is configured via a RRC signaling.

14. The method according to claim 1, wherein:
the ECP resource in a frequency domain is determined according to a frequency range of a multicast common frequency resource (CFR) within a corresponding active DL BWP and a system information signaling comprising a first frequency range for the ECP resource.

15. The method according to claim 14, wherein:
the ECP resource is determined by an overlapping frequency resource between the at least one multicast CFR and the first frequency range; or
a CP type of each multicast CFR is configured via an RRC signaling.

16. The method according to claim 14, wherein:
in response to a subcarrier spacing (SCS) of a multicast CFR within the first frequency range in the frequency domain not supporting ECP, the multicast CFP is determined to be NCP resource.

17. (canceled)

18. The method according to claim 1, wherein:
in response to resources within which PDCCH MOs are configured having different CP types, the PDCCH MOs are determined as MOs for monitoring PDCCH with different CP types, respectively; or
in response to resources within which PDCCH MOs are configured having different SCSs, the PDCCH MOs are determined as MOs for monitoring PDCCH with different SCSs, respectively.

19. The method according to claim 1, wherein:
in response to a MO being within an ECP resource, a number of symbols of the MO is determined according to a configured number of symbols of a CORESET associated with the MO and a first predefined rule; or
in response to a MO being within an ECP resource, a number of resource blocks (RBs) of the MO is determined according to a configured number of RBs of a CORESET associated with the MO and a second predefined rule, wherein
the first predefined rule comprises decreasing the configured number of symbols of the CORESET associated with the MO; or
the second predefined rule comprises increasing the configured number of RBs of the CORSET associated with the MO.

20. (canceled)

21. The method according to claim 1, wherein:
in response to a transmission with a first CP type overlapping with a resource with a second CP type, the transmission is determined to perform one of the following: being dropped from transmission, being punctured for transmission without the overlapping portion, or rate matching around the overlapping portion for transmission.

22. The method according to claim 1, wherein:
in response to a transmission with a first CP type overlapping with a resource with a second CP type, the transmission is determined to change the scheduled resource's location for the transmission according to a predefined rule, wherein the predefined rule comprises changing the scheduled resource's location for the transmission based on an offset in at least one of time domain and frequency domain to avoid overlapping with the resource with the second CP type.

23. (canceled)

24. The method according to claim 1, wherein:
in response to a transmission with a first CP type located within a resource with a second CP type, the time domain position of a demodulation reference signal (DMRS) for the transmission is determined according to a rule for determining a DMRS position of a transmission in the resource with the first CP type.

25. A wireless communications apparatus comprising a processor and a memory, wherein the processor is configured to read code from the memory and implement a method according to claim 1.

26. (canceled)

27. A method for wireless communication, comprising:
configuring, by a base station, extended cyclic prefix (ECP) resource for at least one of broadcast transmission and multicast transmission according to predefined resources; and
transmitting, by the base station to at least one user equipment (UE), a broadcast transmission or multicast transmission in the ECP resource.
